(19) United States
(12) Patent Application Publication
(10) Pub. No.: US 2026/0246204 A1
(43) Pub. Date: Aug. 20, 2026

(54) SHIELD CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shuhei TERADA, Osaka (JP); Kota MATSUO, Osaka (JP); Kazuya KOBAYASHI, Mie (JP); Kaisei HAZEMOTO, Mie (JP); Yusuke ITO, Mie (JP)

(21) Appl. No.: 19/161,320

(22) PCT Filed: Feb. 19, 2024
(86) PCT No.: PCT/JP2024/005735

§ 371 Date: Sep. 2, 2025

(30) Foreign Application Priority Data
Mar. 10, 2023 (JP) 2023-037115

(51) Int. Cl. H01R 13/6582

(52) U.S. Cl. CPC H01R 13/6582

(57) ABSTRACT

A shield connector includes an outer conductor for surrounding an inner conductor and a dielectric, a connecting member to be conductively connected to a shield member for at least partially covering an outer surface of the outer conductor and the outer conductor, a connector housing made of synthetic resin and to be assembled with the outer conductor, a holding portion formed in the connector housing, the connecting member being held through the holding portion, and a projection-like movement restricting portion for restricting a movement of the connecting member in a direction intersecting a passing direction of the connecting member through the holding portion by contacting the connecting member from the direction intersecting the passing direction.

### TECHNICAL FIELD

The present disclosure relates to a shield connector.

### BACKGROUND

Patent Document 1 discloses a connector in which an inner conductor is accommodated in a dielectric and the dielectric is surrounded by an outer conductor. The outer conductor is in contact with an electrically conductive enclosure while being accommodated in the enclosure. By the contact of the outer conductor with the enclosure, shielding performance can be expected to improve.

### PRIOR ART DOCUMENT

### Patent Document

Patent Document 1: JP 2020-109738 A

### SUMMARY OF INVENTION

### Problems to be Solved

Since the outer conductor and the enclosure are in contact by being fit to each other, the contact reliability of the outer conductor and the enclosure is reduced and it is difficult to realize an improvement in shielding performance if dimensional tolerances are large. As a countermeasure against this, it is thought to use a connecting member constituted by a metal plate member and including a spring piece. By attaching the connecting member to the outer conductor and resiliently bringing the spring piece into contact with the enclosure, contact reliability can be improved.

To enhance the contact reliability of the connecting member and the outer conductor, the connecting member needs to be positioned with respect to the outer conductor. A structure for forming a holding portion in a connector housing made of synthetic resin and to be assembled with the outer conductor and fitting the connecting member through this holding portion is thought as an example of a means for holding the connecting member in a state positioned with respect to the outer conductor. However, since the dimensional accuracy of the connector housing made of synthetic resin is not high, the connecting member may move in the holding portion. If the connecting member moves in the holding portion, it causes a contact failure between the connecting member and the outer conductor. If the contact failure occurs between the connecting member and the outer conductor, shielding performance is reduced.

A shield connector of the present disclosure was completed on the basis of the above situation and aims to improve the reliability of shielding performance.

### Means to Solve the Problem

The present disclosure is directed to a shield connector with an outer conductor for surrounding an inner conductor and a dielectric, a connecting member to be conductively connected to a shield member for at least partially covering an outer surface of the outer conductor and the outer conductor, a connector housing made of synthetic resin, the connector housing being assembled with the outer conductor, a holding portion formed in the connector housing, the connecting member being held through the holding portion, and a projection-like movement restricting portion for restricting a movement of the connecting member in a direction intersecting a passing direction of the connecting member through the holding portion by contacting the connecting member from the direction intersecting the passing direction.

### Effect of the Invention

According to the present disclosure, it is possible to improve the reliability of shielding performance.

### BRIEF DESCRIPTION OF THE DRAWINGS

FIG. 1 is a perspective view of a shield connector of a first embodiment when viewed obliquely from front.

FIG. 2 is a perspective view of the shield connector shown in FIG. 1 when viewed obliquely from behind.

FIG. 3 is a front view showing a state where the shield connector shown in FIG. 1 is mounted on a circuit board.

FIG. 4 is an exploded perspective view of the shield connector shown in FIG. 1.

FIG. 5 is a perspective view showing a state where an upper case of an outer conductor and a connecting member of the shield connector shown in FIG. 1 are vertically separated.

FIG. 6 is a front view in section of a connector housing showing the arrangement of movement restricting portions in a holding portion in the first embodiment.

FIG. 7 is a front view in section of the connector housing in a state where the connecting member is held in the holding portion in the first embodiment.

FIG. 8 is a side view in section of the shield connector in the first embodiment.

FIG. 9 is a partial enlarged section of FIG. 8.

FIG. 10 is a section along X-X of FIG. 8.

FIG. 11 is a partial enlarged section of FIG. 10.

FIG. 12 is a partial enlarged plan view in section showing the arrangement of movement restricting portions in a shield connector of a second embodiment.

### DETAILED DESCRIPTION TO EXECUTE THE INVENTION

### Description of Embodiments of Present Disclosure

First, embodiments of the present disclosure are listed and described. Arbitrary combinations of a plurality of the embodiments described below without causing any contradiction are also included in forms for carrying out the invention.

(1) The shield connector of the present disclosure is provided with an outer conductor for surrounding an inner conductor and a dielectric, a connecting member to be conductively connected to a shield member for at least partially covering an outer surface of the outer conductor and the outer conductor, a connector housing made of synthetic resin, the connector housing being assembled with the outer conductor, a holding portion formed in the connector housing, the connecting member being held through the holding portion, and a projection-like movement restricting portion for restricting a movement of the connecting member in a direction intersecting a passing direction of the connecting member through the holding portion by contacting the connecting member from the direction intersecting the passing direction. According to this configuration, since a relative movement of the connecting member with respect to the holding portion can be restricted, a relative movement of the connecting member with respect to the outer conductor is restricted and connection reliability between the connecting member and the outer conductor is improved.

(2) Preferably, a plurality of the movement restricting portions are arranged side by side at intervals. According to this configuration, since a movement of the connecting member is restricted by the plurality of movement restricting portions arranged at intervals, the connecting member can be prevented from being inclined with the movement restricting portions as a fulcrum.

(3) Preferably, in (1) or (2), the connecting member is constituted by a metal plate member, the connecting member is formed with an arm portion for contacting the outer conductor by being resiliently deformed, and a part for contacting the movement restricting portion, out of the connecting member, functions as a fulcrum of resilient deformation of the arm portion. According to this configuration, since a fulcrum of deflection of the arm portion is stabilized by the movement restricting portion, connection reliability between the arm portion and the outer conductor is improved.

(4) Preferably, in (1) or (2), the connecting member is constituted by a metal plate member, the holding portion includes a slit penetrating through the connector housing, one of two long-side inner surfaces along long sides of the slit is formed with a plurality of first movement restricting portions at intervals in a length direction of the long sides, and the other of the two long-side inner surfaces is formed with a second movement restricting portion formed to be located between the plurality of first movement restricting portions in the length direction of the long sides. According to this configuration, since the plate-like connecting member is sandwiched in a plate thickness direction by the first movement restricting portions and the second movement restricting portion arranged alternately, the connecting member is held in a curved state in the holding portion. In this way, the connecting member can be restricted from relatively moving in the length direction of the long sides with respect to the holding portion.

### Details of Embodiments of Present Disclosure

### First Embodiment

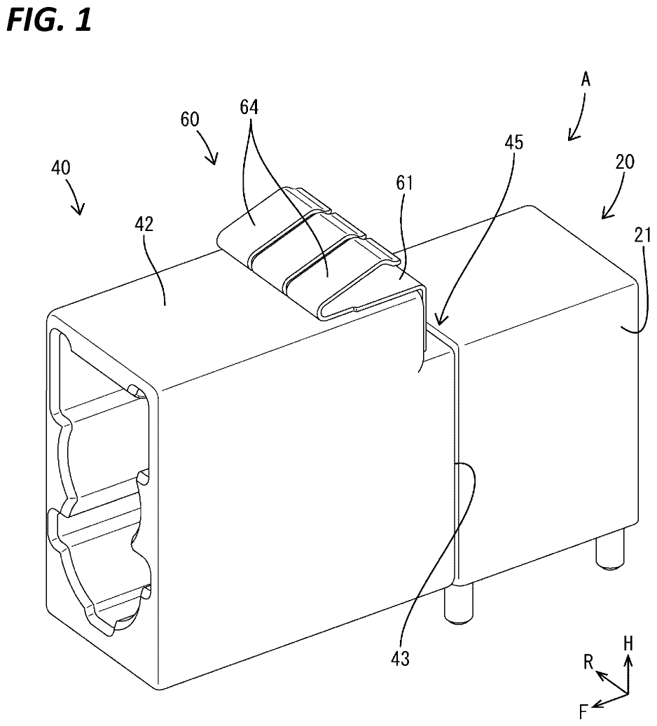

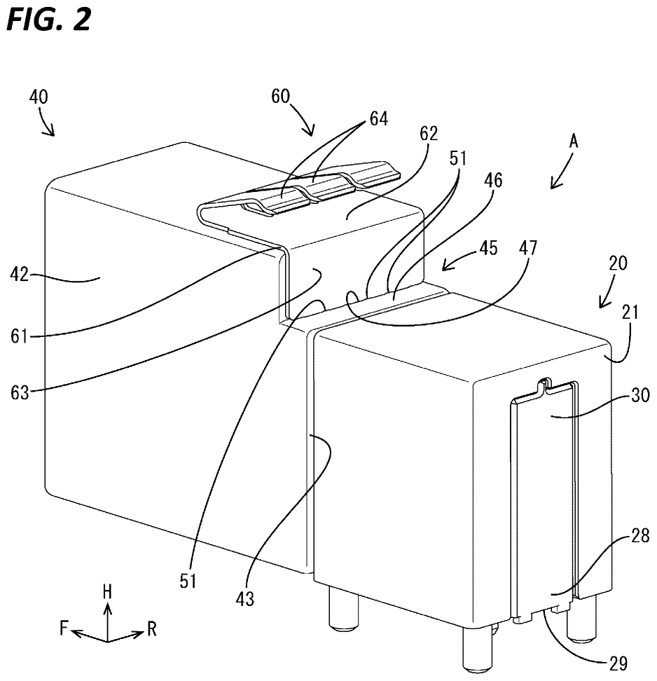

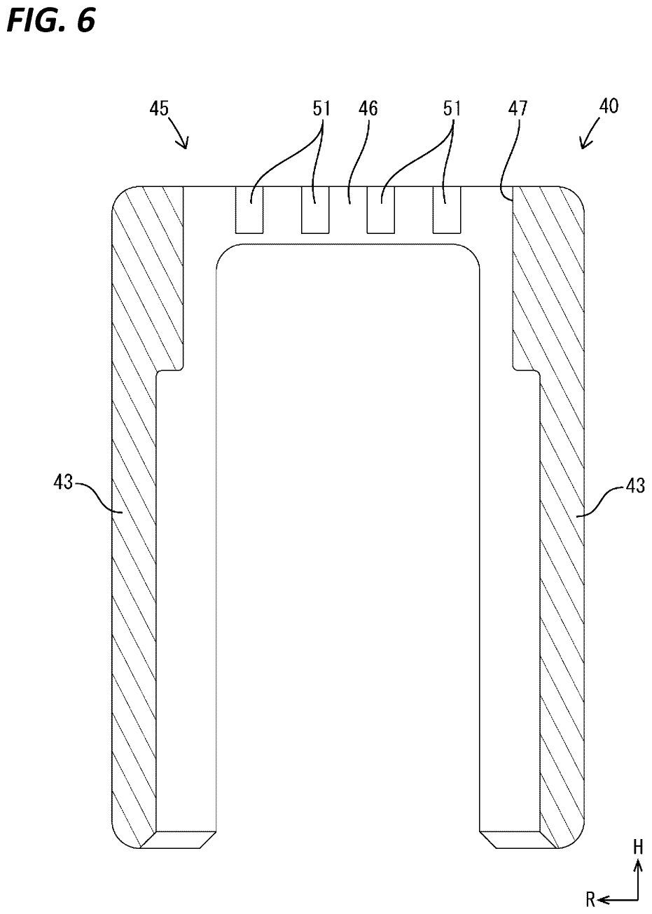

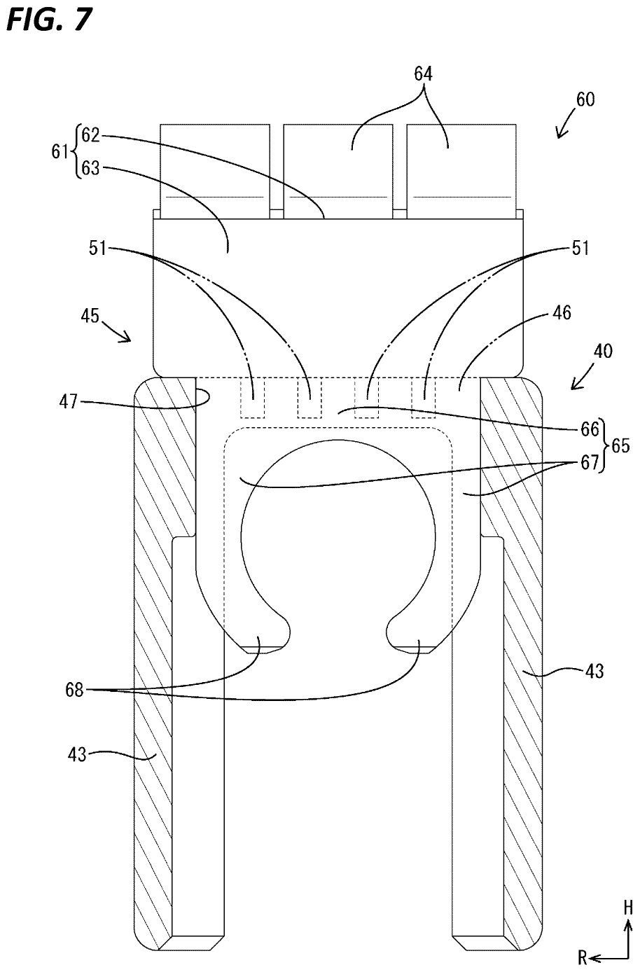

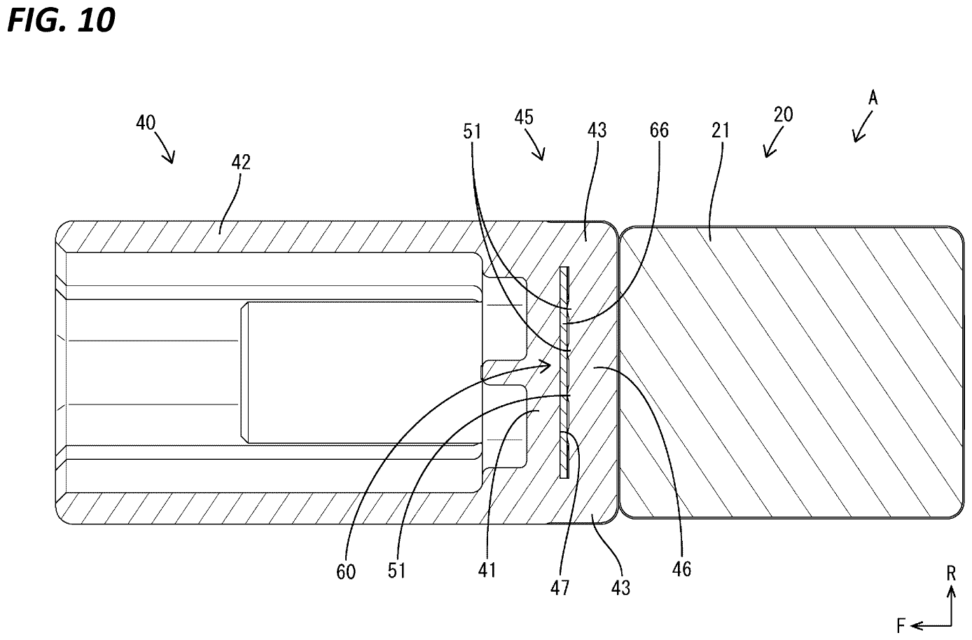

A shield connector A of a first specific embodiment of the present disclosure is described with reference to FIGS. 1 to 11. The present invention is not limited to these illustrations, but is represented by claims and intended to include all changes in the scope of claims and in the meaning and scope of equivalents. In this embodiment, a direction Fin FIGS. 1, 2, 4, 5 and 8 to 11 is defined as a forward direction concerning a front-rear direction. A direction R in FIGS. 1 to 7, 10 and 11 is defined as a rightward direction concerning a lateral direction. The lateral direction is used as synonymous with a width direction. A direction H in FIGS. 1 to 9 is defined as an upward direction concerning a vertical direction.

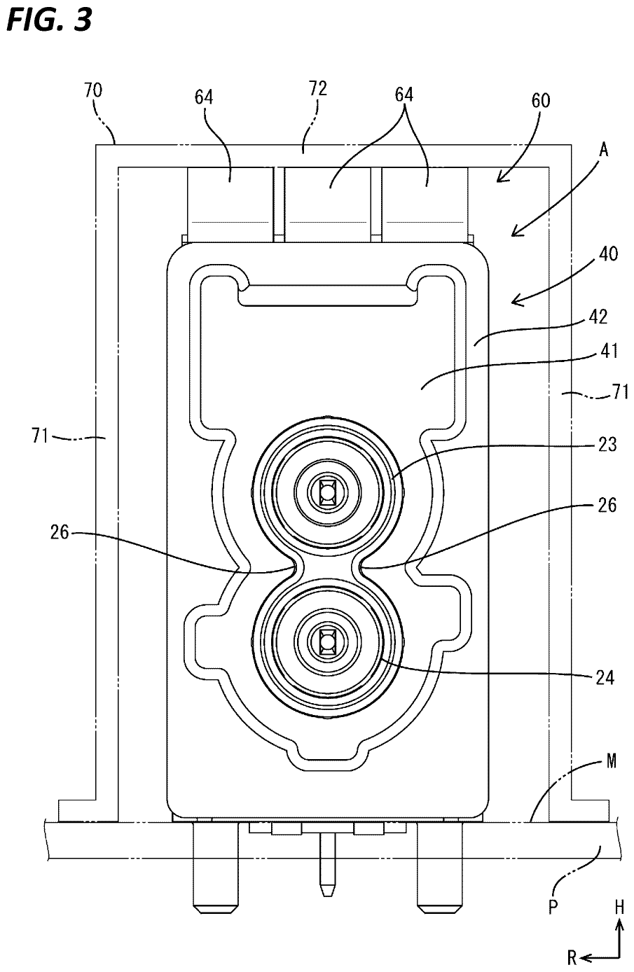

The shield connector A of the first embodiment is, as shown in FIG. 3, a board connector to be mounted on a mounting surface M of a circuit board P. A box-shaped shield member 70 made of an electrically conductive material such as metal is mounted on the mounting surface M. The shield member 70 covers at least a part of the outer surface of an outer conductor 20 to be described later. The shield connector A is at least partially arranged inside the shield member 70. In a front view of the circuit board P, the shield member 70 has a rectangular shape. The shield member 70 includes a pair of left and right side plate portions 71 and a horizontal upper plate portion 72 connecting the upper end edges of the both side plate portions 71. A lower end part of the side plate portion 71 is connected to a ground circuit (not shown) of the circuit board P.

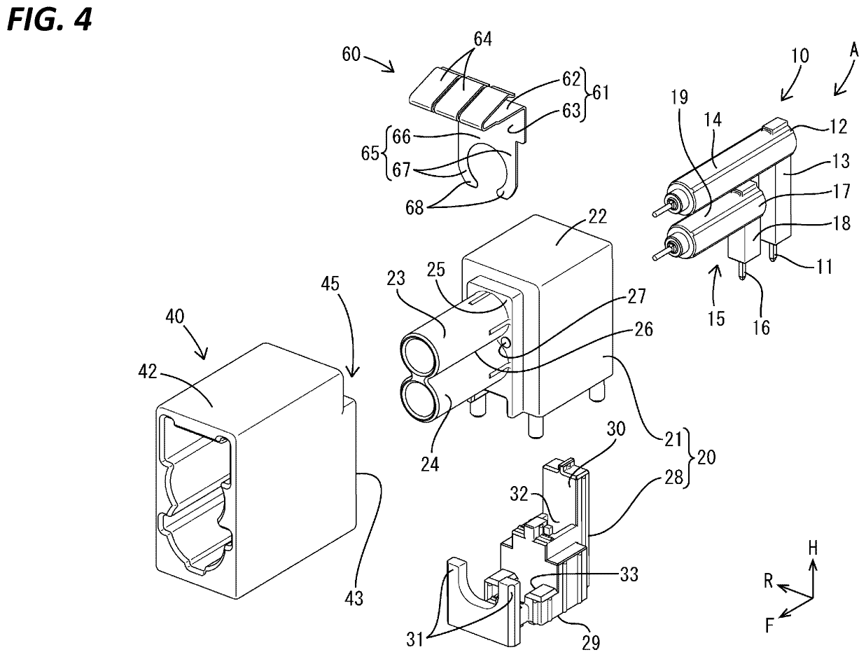

As shown in FIG. 4, the shield connector A is configured by assembling a first terminal module 10, a second terminal module 15, the outer conductor 20, a connector housing 40 and a connecting member 60.

The first terminal module 10 is provided with an L-shaped first inner conductor 11 and an L-shaped first dielectric 12 for accommodating the first inner conductor 11. The first dielectric 12 includes a first mounting-side surrounding portion 13 extending in the vertical direction and a first fitting-side surrounding portion 14 projecting forward from an upper end part of the first mounting-side surrounding portion 13. The second terminal module 15 is provided with an L-shaped second inner conductor 16 and an L-shaped second dielectric 17 for accommodating the second inner conductor 16. The second dielectric 17 includes a second mounting-side surrounding portion 18 extending in the vertical direction and a second fitting-side surrounding portion 19 projecting forward from an upper end part of the second mounting-side surrounding portion 18.

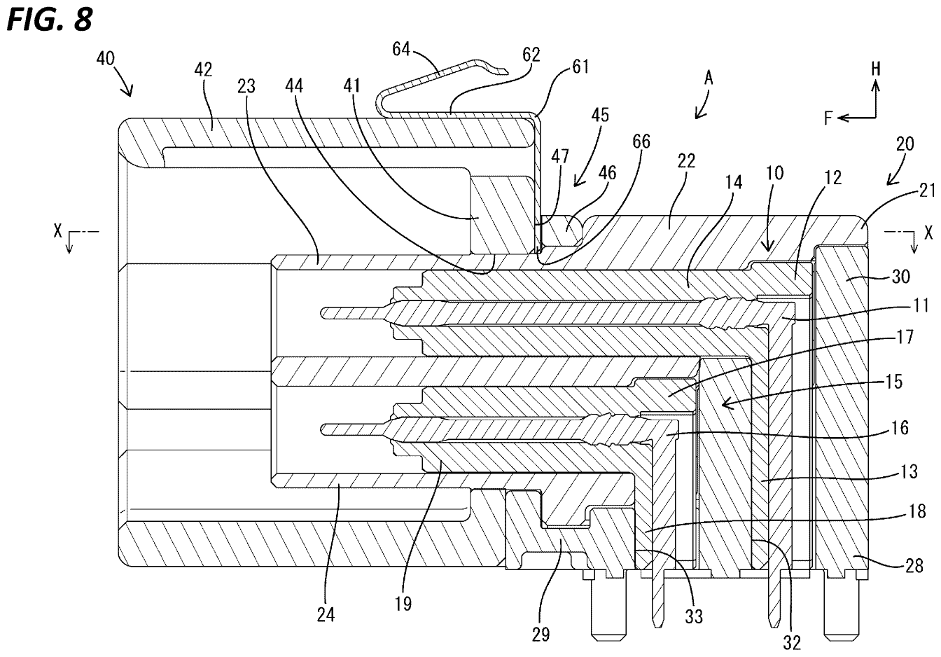

As shown in FIGS. 4 and 8, the outer conductor 20 is configured by assembling an upper case 21 and a lower case 28. The upper case 21 is a single component made of metal and formed by forging or casting. The upper case 21 includes a box-shaped accommodating portion 22, a first hollow cylindrical portion 23 and a second hollow cylindrical portion 24. The box-shaped accommodating portion 22 has a rectangular parallelepiped shape with open rear and lower surfaces. A projecting portion 25 is formed in a rectangular region except an upper edge part and both left and right side edge parts on the front surface of the box-shaped accommodating portion 22.

As shown in FIG. 4, the first hollow cylindrical portion 23 is a part having an axis oriented in the front-rear direction and projecting forward from the front surface of the projecting portion 25. The second hollow cylindrical portion 24 is a part having an axis oriented in parallel to the first hollow cylindrical portion 23 and projecting forward from the front surface of the projecting portion 25 below the first hollow cylindrical portion 23. The first and second hollow cylindrical portions 23, 24 are connected to each other and form an 8 shape in a front view. A pair of left and right constricted portions 26 are formed between the first and second hollow cylindrical portions 23, 24. A pair of left and right projection-like contact point portions 27 are formed on the front surface of the projecting portion 25. In the front view, the pair of contact point portions 27 are arranged in the constricted portions 26.

The lower case 28 is a single component made of metal and formed by forging or casting. As shown in FIG. 4, the lower case 28 includes a bottom wall portion 29, a closing portion 30 and a pair of left and right pressing portions 31. As shown in FIG. 8, the bottom wall portion 29 is formed with a first through hole 32 and a second through hole 33 penetrating through the bottom wall portion 29 in the vertical direction. The second through hole 33 is located forward of the first through hole 32. The closing portion 30 is in the form of a wall projecting upward from a rear end part of the bottom wall portion 29. The pair of pressing portions 31 are shaped to project upward from a front end part of the bottom wall portion 29.

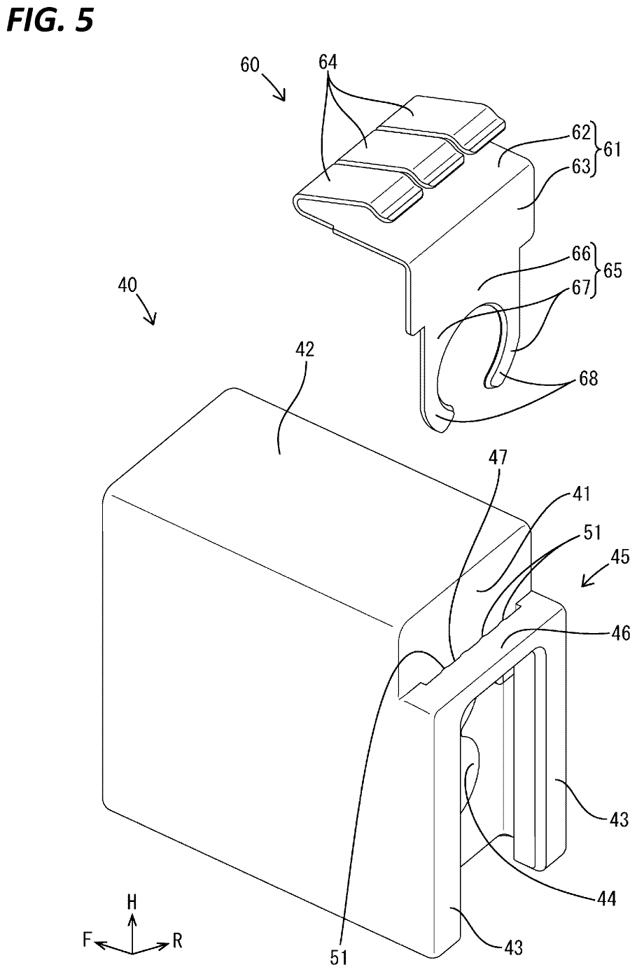

The connector housing 40 is a box-shaped single component made of synthetic resin and having a rectangular parallelepiped shape as a whole. As shown in FIG. 5, the connector housing 40 includes a rear wall portion 41 having a thickness direction oriented in the front-rear direction, a receptacle 42 in the form of a rectangular tube projecting forward from the outer peripheral edge of the rear wall portion 41, a pair of bilaterally symmetrical rib-like fitting portions 43 and a holding portion 45. The rear wall portion 41 is formed with a fitting hole 44 penetrating through the rear wall portion 41 in the front-rear direction. The pair of rib-like fitting portions 43 are formed to be elongated in the vertical direction along both left and right side edges of the rear wall portion 41. In a top view of the connector housing 40, each rib-like fitting portion 43 has an L shape projecting rearward from the rear surface of the rear wall portion 41 and projecting inward in the width direction from the projecting end of the rearward projecting part.

The holding portion 45 is provided with an upper end part of the rear surface of the rear wall portion 41 and a beam portion 46 elongated in the lateral direction. Both left and right end parts of the beam portion 46 are connected to upper end parts of the pair of rib-like fitting portions 43. The beam portion 46 is arranged to face the rear surface of the rear wall portion 41 while being spaced apart. The holding portion 45 includes a slit 47 formed between the rear surface of the rear wall portion 41 and the front surface of the beam portion 46. For example, the slit 47 penetrates through the connector housing 40 in the vertical direction. The slit 47 is a space elongated in the lateral direction and open in both upper and lower surfaces.

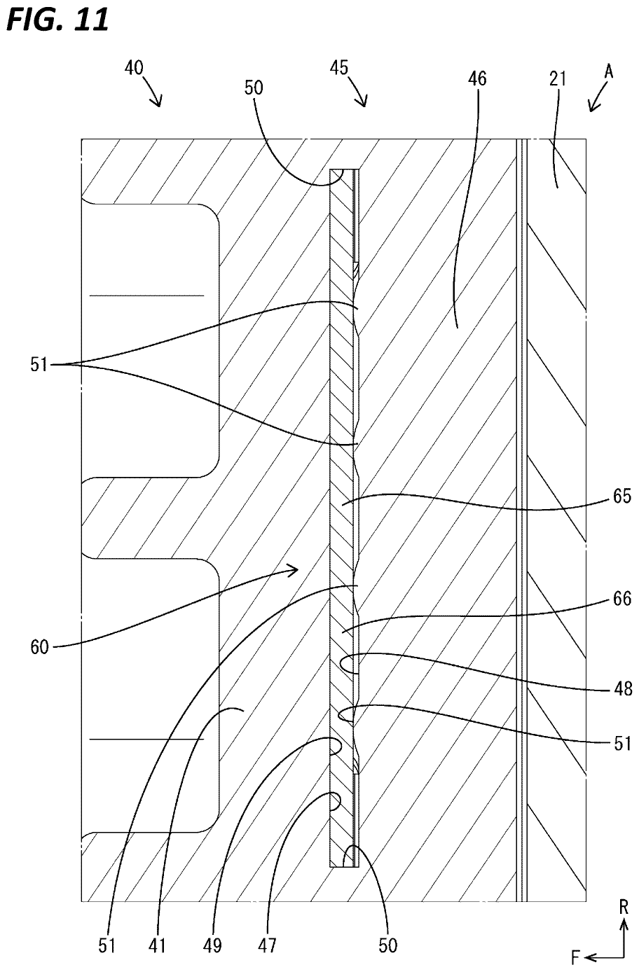

As shown in FIG. 11, the slit 47 is defined by a first long-side inner surface 48, a second long-side inner surface 49 and a pair of left and right short-side inner surfaces 50. The front surface of the beam portion 46 constitutes the first long-side inner surface 48. The rear surface of the rear wall portion 41 constitutes the second long-side inner surface 49. The side surface of the rib-like fitting portion 43 constitutes the short-side inner surface 50.

The first long-side inner surface 48 is formed with a plurality of movement restricting portions 51 spaced apart in the width direction. The movement restricting portion 51 is shaped to project forward from the first long-side inner surface 48. A formation range of the movement restricting portion 51 in the vertical direction is a range from the upper end to the lower end of the slit 47. In a plan view, the outer peripheral edge on a projecting side of each movement restricting portion 51 has an arcuate or elliptical shape. A horizontal cross-sectional shape of the movement restricting portion 51 is, for example, a constant shape over an entire region from the upper end to the lower end of the movement restricting portion 51. For example, no movement restricting portions 51 are formed on the second long-side inner surface 49 and the short-side inner surfaces 50.

The connecting member 60 is a single component formed by bending a metal plate member punched out into a predetermined shape. As shown in FIGS. 4 and 5, the connecting member 60 includes a base portion 61, a plurality of spring pieces 64 and an arm portion 65. The base portion 61 includes a horizontal plate portion 62 in the form of a rectangular flat plate having a thickness direction oriented in the vertical direction and a vertical plate portion 63 in the form of a rectangular flat plate extending downward from the rear end edge of the horizontal plate portion 62. In a side view of the connecting member 60, the base portion 61 is L-shaped. The plurality of (three in the first embodiment) spring pieces 64 have a cantilever shape obliquely extending to an upper rear side from the front end edge of the horizontal plate portion 62, and are arranged side by side in the width direction. The spring pieces 64 are resiliently deformable in the vertical direction with the front end edges of the spring pieces 64 (front end edge of the horizontal plate portion 62) as a fulcrum. As shown in FIG. 3, the connecting member 60 can contact the shield member 70 while resiliently deforming the spring pieces 64. By resiliently bringing the connecting member 60 into contact with the shield member 70, contact stability can be improved.

As shown in FIGS. 4 and 5, the arm portion 65 is in the form of a flat plate having a plate thickness direction oriented in the front-rear direction, and connected and flush with the vertical plate portion 63. A plate thickness of the arm portion 65 is slightly larger than a minimum interval in the front-rear direction between the movement restricting portions 51 of the holding portion 45 and the second long-side inner surface 49. The arm portion 65 includes a base end portion 66 and a pair of bilaterally symmetrical resilient contact pieces 67. The base end portion 66 is a part narrower than the vertical plate portion 63. The pair of resilient contact pieces 67 are cantilevered downward from the lower end edge of the base end portion 66. The lower end edge of the base end portion 66 and the inner side edges of the both left and right resilient contact pieces 67 are connected to form an arcuate shape interrupted in a lower end part. Lower end regions of the pair of resilient contact pieces 67 are curved to narrow a facing interval in the width direction toward a lower side and function as retaining portions 68.

An assembly procedure of the shield connector A is described. In the outer conductor 20, the first terminal module 10 is inserted into the box-shaped accommodating portion 22 from behind the upper case 21 and the first fitting-side surrounding portion 14 is fit into the first hollow cylindrical portion 23 with the upper and lower cases 21, 28 separated. The second terminal module 15 is also inserted into the box-shaped accommodating portion 22 from behind the upper case 21 and the second fitting-side surrounding portion 19 is fit into the second hollow cylindrical portion 24.

In the connector housing 40, the connecting member 60 is attached to the holding portion 45. The horizontal plate portion 62 of the base portion 61 is brought into contact with a rear end part of the upper surface of the receptacle 42 and the vertical plate portion 63 thereof is positioned while being held in contact with an upper end part of the rear surface of the rear wall portion 41. The arm portion 65 is press-fit into and inserted through the slit 47 of the holding portion 45 from above the connector housing 40. As shown in FIG. 11, in the slit 47, the base end portion 66 of the arm portion 65 is sandwiched in the front-rear direction between the plurality of movement restricting portions 51 and the second long-side inner surface 49. That is, the plurality of movement restricting portions 51 contact the base end portion 66 of the arm portion 65 from a direction intersecting a passing direction of the arm portion 65 through the holding portion 45. For example, the plurality of movement restricting portions 51 contact the base end portion 66 from behind in a direction orthogonal to the vertical direction. Then, the plurality of movement restricting portions 51 press the base end portion 66 of the arm portion 65 toward the second long-side inner surface 49. The base end portion 66 of the arm portion 65 is accommodated into the slit 47, and the resilient contact pieces 67 project downward from the holding portion 45 (slit 47).

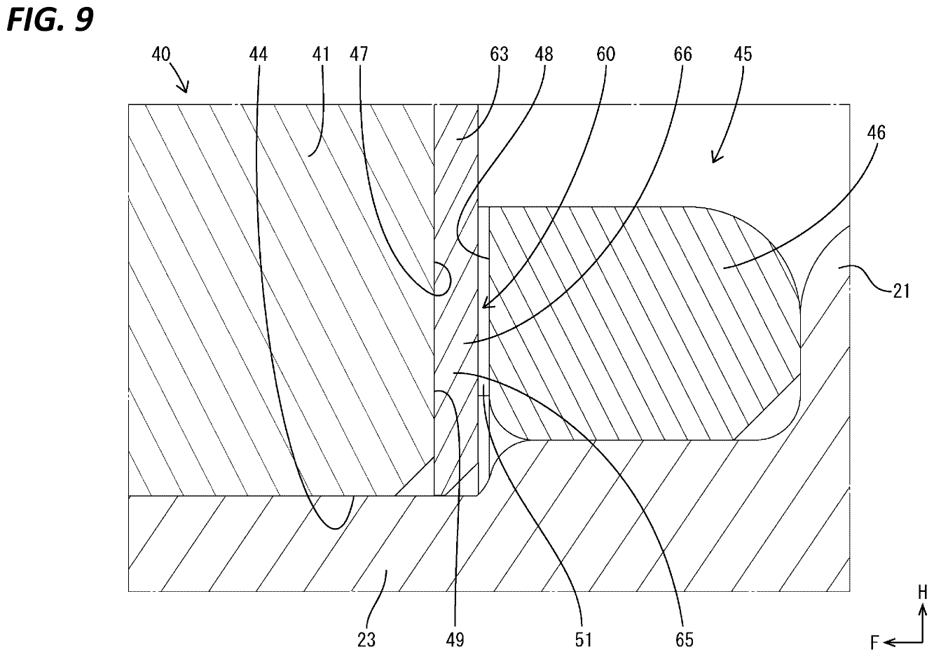

By being sandwiched, the connecting member 60 is held in the holding portion 45 of the connector housing 40 with movements in the front-rear direction restricted. As shown in FIG. 9, since the movement restricting portions 51 and the second long-side inner surface 49 are in contact with the arm portion 65 over a predetermined dimension in the vertical direction, the connecting member 60 is not inclined in the front-rear direction with respect to the connector housing 40. Further, since the movement restricting portions 51 are arranged at a plurality of positions spaced apart in the width direction (lateral direction) of the holding portion 45, the connecting member 60 is not inclined in the lateral direction with respect to the connector housing 40.

Subsequently, the upper case 21 is assembled with the connector housing 40 from behind. At this time, the first and second hollow cylindrical portions 23, 24 are press-fit into and passed through the fitting hole 44 of the rear wall portion 41 and arranged to protrude forward in the receptacle 42. The first hollow cylindrical portion 23 is fit to the arm portion 65. In particular, the pair of resilient contact pieces 67 sandwich the first hollow cylindrical portion 23 from left and right, whereby the connecting member 60 is restricted from being relatively displaced in the lateral direction with respect to the upper case 21 (outer conductor 20 and connector housing 40). The retaining portions 68 of the pair of resilient contact pieces 67 are fit into the constricted portions 26, whereby the connecting member 60 is restricted from being separated upward from the upper case 21.

After the upper case 21 is assembled with the connector housing 40, the lower case 28 is assembled with the upper case 21 by being press-fit from below. The first mounting-side surrounding portion 13 is accommodated into the first through hole 32, and the second mounting-side surrounding portion 18 is accommodated into the second through hole 33. The rib-like fitting portions 43 are sandwiched in the front-rear direction between the pair of pressing portions 31 and the front surface of the box-shaped accommodating portion 22, whereby the upper case 21 and the connector housing 40 are restricted from being separated in the front-rear direction. In the above way, the assembly of the shield connector A is completed.

The projecting portion 25 of the upper case 21 is fit into a space surrounded by the holding portion 45 and the pair of rib-like fitting portions 43. The rear surfaces of the pair of retaining portions 68 (lower end parts of the pair of resilient contact pieces 67) of the connecting member 60 contact the pair of contact point portions 27 on the front surface of the projecting portion 25. In this way, the connecting member 60 and the outer conductor 20 (upper case 21) are conductively connected. At this time, the resilient contact pieces 67 of the arm portion 65 are pushed slightly forward by the contact point portions 27, thereby being slightly resiliently deformed to be displaced forward with the base end portion 66 as a fulcrum. In particular, the arm portion 65 is resiliently deformed with contact parts of the connecting member 60 with the movement restricting portions 51 as a fulcrum. By the resilient deformation of the resilient contact pieces 67, a contact pressure is ensured between the arm portion 65 and the contact point portions 27.

The assembled shield connector A is mounted on the mounting surface M of the circuit board P while being accommodated inside the shield member 70. With the shield connector A mounted on the circuit board P, the spring pieces 64 of the connecting member 60 resiliently contact the upper plate portion 72 of the shield member 70 and the outer conductor 20 and the shield member 70 are conductively connected. In this way, a good shielding function is exhibited.

The shield connector A of the first embodiment is provided with the outer conductor 20 for surrounding the inner conductors 11, 16 and the dielectrics 12, 17, the connecting member 60 and the connector housing 40. The connecting member 60 is conductively connected to the outer conductor 20 and the shield member 70. The shield member 70 covers at least a part of the outer surface of the outer conductor 20. The connector housing 40 is a component made of synthetic resin and assembled with the outer conductor 20. The connector housing 40 is formed with the holding portion 45 for holding the arm portion 65 of the connecting member 60 passed therethrough.

The projection-like movement restricting portions 51 are formed on the inner surface (first long-side inner surface 48) of the holding portion 45. The movement restricting portions 51 restrict a movement of the connecting member 60 in the front-rear direction by contacting the connecting member 60 from the front-rear direction intersecting the passing direction of the connecting member 60 through the holding portion 45. The resilient contact pieces 67 of the connecting member 60 contact the contact point portions 27 of the outer conductor 20 from front. Since a relative movement of the connecting member 60 (arm portion 65) in the front-rear direction with respect to the holding portion 45 can be restricted by the action of the movement restricting portions 51, a relative movement of the connecting member 60 (resilient contact pieces 67) with respect to the outer conductor 20 is restricted and connection reliability between the connecting member 60 (resilient contact pieces 67) and the outer conductor 20 is improved.

In the slit 47, the plurality of movement restricting portions 51 are arranged side by side at intervals in the width direction. According to this configuration, a movement of the connecting member 60 is restricted by the plurality of movement restricting portions 51 arranged at intervals. Therefore, it can be prevented that the connecting member 60 is inclined in the front-rear direction with the movement restricting portions 51 as a fulcrum in a plan view.

The connecting member 60 is constituted by a metal plate member. The connecting member 60 is formed with the arm portion 65 for resiliently contacting the contact point portions 27 of the outer conductor 20 by being resiliently deformed. Out of the connecting member 60, the base end portion 66, which is a part for contacting the movement restricting portions, functions as a fulcrum of resilient deformation of the resilient contact pieces 67 of the arm portion 65. Since the base end portion 66 serving as a fulcrum of deflection of the arm portion 65 is stabilized by being sandwiched by the movement restricting portions 51, connection reliability between the arm portion 65 and the outer conductor 20 is improved.

### Second Embodiment

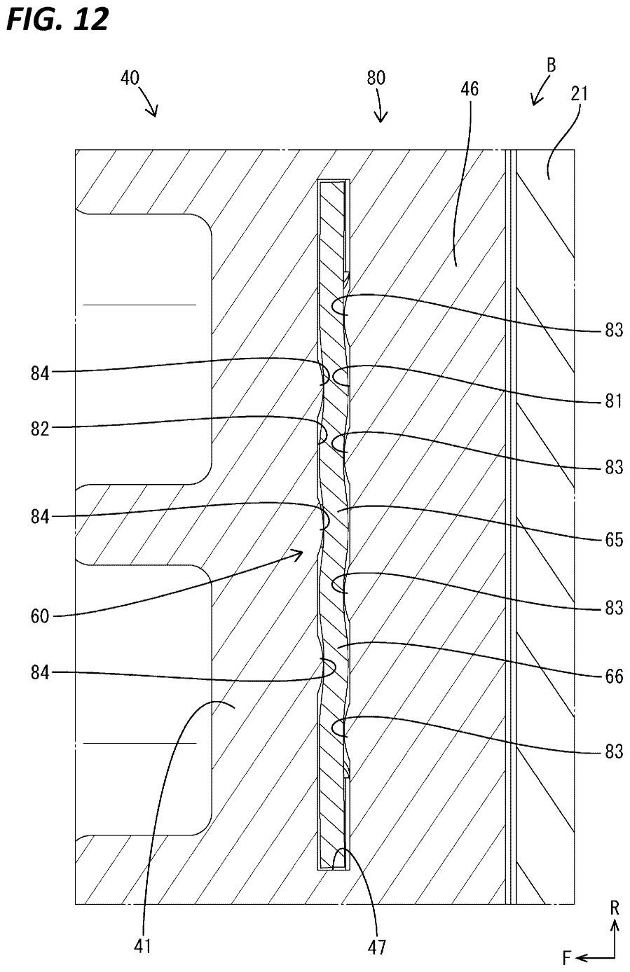

A shield connector B of a second specific embodiment of the present disclosure is described with reference to FIG. 12. The shield connector B of the second embodiment differs from the first embodiment in movement restricting portions 83, 84 formed in a holding portion 80. Since the other configuration is the same as in the first embodiment, the same components are denoted by the same reference signs and the structures, functions and effects thereof are not described.

A connecting member 60 of the second embodiment is the same component as the connecting member 60 of the first embodiment. A basic structure of the holding portion 80 is the same as in the first embodiment. In the second embodiment, the movement restricting portions 83, 84 are formed on both a first long-side inner surface 81 and a second long-side inner surface 82. In particular, a plurality of first movement restricting portions 83 are formed at intervals in the width direction (lateral direction) on the first long-side inner surface 81. A plurality of second movement restricting portions 84 are formed at intervals in the width direction (lateral direction) on the second long-side inner surface 82.

The plurality of second movement restricting portions 84 are formed to be located between the plurality of first movement restricting portions 83 in a length direction (width direction) of long sides of the slit 47. In other words, in a plan view, the plurality of first movement restricting portions 83 and the plurality of second movement restricting portions 84 are arranged in a staggered manner. According to this configuration, the plate-like base end portion 66 of the connecting member 60 is sandwiched in a plate thickness direction by the first movement restricting portions 83 and the second movement restricting portions 84 arranged alternately. In this way, the base end portion 66 is held in a state slightly curved into a wave in the holding portion 80 (slit 47). Note that the base end portion 66 is drawn with an exaggerated curving degree in FIG. 12. By holding the base end portion 66 in the state slightly curved into a wave, the arm portion 65 (connecting member 60) can be restricted from relatively moving in the length direction of the long sides with respect to the holding portion 80 and the outer conductor 20.

### Other Embodiments

The present invention is not limited to the above described and illustrated embodiments, but is represented by claims. The present invention includes all changes in the scope of claims and in the meaning and scope of equivalents and also includes the following embodiments.

In the first and second embodiments, the connecting member may be shaped not to include the arm portion.

In the first embodiment, only one movement restricting portion may be formed in the holding portion.

In the second embodiment, the first movement restricting portions and the second movement restricting portions may be arranged at the same positions in the length direction of the long sides.

### LIST OF REFERENCE NUMERALS

B . . . shield connector
M . . . mounting surface
P . . . circuit board
10 . . . first terminal module
11 . . . first inner conductor
12 . . . first dielectric
13 . . . first mounting-side surrounding portion
14 . . . first fitting-side surrounding portion
15 . . . second terminal module
16 . . . second inner conductor
17 . . . second dielectric
18 . . . second mounting-side surrounding portion
19 . . . second fitting-side surrounding portion
20 . . . outer conductor
21 . . . upper case
22 . . . box-shaped accommodating portion
23 . . . first hollow cylindrical portion
24 . . . second hollow cylindrical portion
25 . . . projecting portion
26 . . . constricted portion
27 . . . contact point portion
28 . . . lower case
29 . . . bottom wall portion
30 . . . closing portion
31 . . . pressing portion
32 . . . first through hole
33 . . . second through hole
40 . . . connector housing
41 . . . rear wall portion
42 . . . receptacle
43 . . . rib-like fitting portion
44 . . . fitting hole
45 . . . holding portion
46 . . . beam portion
47 . . . slit
48 . . . first long-side inner surface
49 . . . second long-side inner surface
50 . . . short-side inner surface
51 . . . movement restricting portion
60 . . . connecting member
61 . . . base portion
62 . . . horizontal plate portion
63 . . . vertical plate portion
64 . . . spring piece
65 . . . arm portion
66 . . . base end portion
67 . . . resilient contact piece
68 . . . retaining portion
70 . . . shield member
71 . . . side plate portion
72 . . . upper plate portion
80 . . . holding portion
81 . . . first long-side inner surface (one long-side inner surface)
82 . . . second long-side inner surface (other long-side inner surface)
83 . . . first movement restricting portion (movement restricting portion)
84 . . . second movement restricting portion (movement restricting portion)

1. A shield connector, comprising:
an outer conductor for surrounding an inner conductor and a dielectric;
a connecting member to be conductively connected to a shield member for at least partially covering an outer surface of the outer conductor and the outer conductor;
a connector housing made of synthetic resin, the connector housing being assembled with the outer conductor;
a holding portion formed in the connector housing, the connecting member being held through the holding portion; and
a projection-like movement restricting portion for restricting a movement of the connecting member in a direction intersecting a passing direction of the connecting member through the holding portion by contacting the connecting member from the direction intersecting the passing direction.

2. The shield connector of claim 1, wherein a plurality of the movement restricting portions are arranged side by side at intervals.

3. The shield connector of claim 1 wherein:
the connecting member is constituted by a metal plate member,
the connecting member is formed with an arm portion for contacting the outer conductor by being resiliently deformed, and
a part for contacting the movement restricting portion, out of the connecting member, functions as a fulcrum of resilient deformation of the arm portion.

4. The shield connector of claim 1 wherein:
the connecting member is constituted by a metal plate member,
the holding portion includes a slit penetrating through the connector housing,
one of two long-side inner surfaces along long sides of the slit is formed with a plurality of first movement restricting portions at intervals in a length direction of the long sides, and
the other of the two long-side inner surfaces is formed with a second movement restricting portion formed to be located between the plurality of first movement restricting portions in the length direction of the long sides.
